(19) United States
(12) Patent Application Publication
(10) Pub. No.: US 2026/0362402 A1
(43) Pub. Date: Nov. 12, 2026

(54) FRAMES FOR FEATURE SUPPORT IN INTEGRATED MILLIMETER WAVE OPERATION

(71) Applicant: Cisco Technology, Inc., San Jose, CA (US)

(72) Inventors: Matthew Aaron Silverman, Shaker Heights, OH (US); Ardalan Alizadeh, Milpitas, CA (US); Peiman Amini, Fremont, CA (US); Brian D. Hart, Sunnyvale, CA (US)

(21) Appl. No.: 19/673,094

(22) Filed: May 11, 2026

Related U.S. Application Data
(60) Provisional application No. 63/803,638, filed on May 10, 2025.
(60) Provisional application No. 63/804,389, filed on May 12, 2025.

(51) Int. Cl. H04W 72/0446; H04L 1/00

(52) U.S. Cl. CPC H04W 72/0446; H04L 1/0003; H04L 1/0009

(57) ABSTRACT

Frames for feature support in Integrated millimeter Wave (ImmW) operation, including for basic service set (BSS) color and spatial reuse support, may be provided. Providing BSS color and spatial reuse support includes generating, by an access point (AP) operating in an ImmW frequency band, an ImmW frame, including repurposing one or more bits of a signal (SIG) field of a physical layer preamble of the ImmW frame to carry at least one of BSS color information or spatial reuse information. The AP then transmits the ImmW frame to a station (STA).

### RELATED APPLICATIONS

Applicant claims the benefit of and priority to U.S. Provisional Application No. 63/803,638, filed May 10, 2025, and U.S. Provisional Application No. 63/804,389, filed May 12, 2025, the disclosures of which are incorporated herein by reference in their entirety.

### TECHNICAL FIELD

The present disclosure relates generally to providing frames for feature support in integrated millimeter wave operation, including for basic service set color and spatial reuse support.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1A illustrates an operating environment for providing frames that support basic service set (BSS) coloring and spatial reuse in Integrated millimeter Wave (ImmW) operation in accordance with aspects of the present disclosure.

FIG. 1B illustrates overlapping access point (AP) coverage areas in the operating environment in accordance with aspects of the present disclosure.

FIG. 2 illustrates a Very High Throughput (VHT)-Signal (SIG)-A1 symbol of a VHT-SIG-A field in accordance with aspects of the present disclosure.

FIG. 3 illustrates a VHT-SIG-A2 symbol of a VHT-SIG-A field in accordance with aspects of the present disclosure.

FIG. 4 illustrates a VHT-SIG-B field in accordance with aspects of the present disclosure.

FIG. 5 is a flow diagram illustrating a method for providing frames that support BSS coloring and spatial reuse in ImmW operation in accordance with aspects of the present disclosure.

FIG. 6 is a block diagram of a computing device in accordance with aspects of the present disclosure.

FIG. 7 is a block diagram of a communications device in accordance with aspects of the present disclosure.

### DETAILED DESCRIPTION

### OVERVIEW

Frames for feature support in Integrated millimeter Wave (ImmW) operation, including for basic service set (BSS) color and spatial reuse support, may be provided. Providing BSS color and spatial reuse support includes generating, by an access point (AP) operating in an ImmW frequency band, an ImmW frame, including repurposing one or more bits of a signal (SIG) field of a physical layer preamble of the ImmW frame to carry at least one of BSS color information or spatial reuse information. The AP then transmits the ImmW frame to a station (STA).

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11bq working group is developing standards focused on Integrated millimeter Wave (ImmW) operation. ImmW operation uses high-frequency, unlicensed bands between 42 Gigahertz (GHz) and 71 GHz. These high frequencies enable fast data rates over short ranges, making ImmW well-suited for high-speed, short-range bursts of data transmission (e.g., for streaming video, wireless docking, virtual reality, and augmented reality applications) while traditional bands, such as 2.4 GHz, 5 GHz, and 6 GHz, continue to provide broader coverage and reliability. Because ImmW is limited to single-user (SU) transmissions, such as SU Orthogonal Frequency-Division Multiplexing (OFDM) transmissions, Multi-User (MU) capabilities, including Multi-User, Multiple-Input, Multiple-Output (MU-MIMO), are not supported.

Very High Throughput (VHT) (i.e., Wi-Fi 5) format Physical (PHY) layer frames are used in ImmW operation because the subcarrier spacing defined for VHT is well-suited to operation at frequencies between 42 GHz and 71 GHz (e.g., at 60 GHz). These high frequencies are more susceptible to phase noise compared to sub-7 GHz bands, and the VHT subcarrier spacing provides improved phase noise tolerance. Using VHT frames also allows devices to leverage existing silicon and hardware implementations. VHT PHY layer frames include VHT-Signal (SIG) fields, specifically VHT-SIG-A and VHT-SIG-B, in the frame preamble. VHT-SIG-A contains information necessary for all users to interpret a packet, including channel bandwidth, group identifier (ID), and Modulation and Coding Scheme (MCS), and is spread across two symbols: VHT-SIG-A1 and VHT-SIG-A2. VHT-SIG-B contains user-specific information, such as the length of the data field, and includes reserved bits whose quantity depends on the channel bandwidth.

Because ImmW restricts operation to SU transmissions only, a number of bits within the VHT-SIG fields that were designed to support MU operation become unnecessary. Specifically, the six Group ID bits in VHT-SIG-A, which identify MU transmission groups, carry no meaningful information in the SU-only ImmW context. Similarly, Space-Time Block Coding (STBC) is not planned to be supported in ImmW and is being phased out beginning with IEEE 802.11bn, making the STBC bit in VHT-SIG-A likewise unnecessary. In addition, VHT-SIG-A includes three reserved bits, and VHT-SIG-B includes two to three reserved bits depending on bandwidth, none of which carry defined information. Further, because ImmW supports fewer spatial streams than sub-7 GHz operation, two of the three Number of Spatial Streams (NSS) field bits (e.g., comprising Number of Space-Time Streams (NSTS) bits) and one or more of the four MCS bits are also candidates for repurposing, yielding additional available bits. Across VHT-SIG-A, this results in approximately ten to thirteen bits that serve no functional purpose in ImmW operation and can be repurposed for other features. Additionally, two to three bits of the VHT-SIG-B are able to be repurposed for a maximum total of sixteen usable bits.

A Basic Service Set (BSS) includes an access point (AP) and the client devices associated with that AP. In dense wireless environments, multiple BSSs may overlap on the same channel. Without a mechanism to distinguish between BSSs, devices must defer transmission whenever they detect a signal from any neighboring BSS, regardless of whether that signal is strong enough to cause actual interference, wasting airtime and reducing throughput. BSS coloring addresses this problem by assigning a numerical “color” identifier to each BSS. A device can identify frames from its own BSS by their matching color value and can recognize frames from a neighboring BSS by a different color value. Using these color values, a device can perform spatial reuse; if a signal from a neighboring BSS carries a different color and falls below a threshold at which it would cause harmful interference, the device may transmit simultaneously rather than deferring. Supporting BSS coloring and spatial reuse in the manner defined in IEEE 802.11ax requires six BSS color bits and four spatial reuse bits for ten bits in total.

Adding new fields to a frame to carry BSS color and spatial reuse information would increase frame length, adding overhead and reducing efficiency. Further, ImmW operation requirements may not allow for the addition of bits for BSS coloring and spatial reuse. By repurposing the unused and unnecessary bits within VHT-SIG-A and VHT-SIG-B to carry BSS color and spatial reuse information in ImmW operation, BSS coloring and spatial reuse is supported without adding any overhead to the transmitted frame. For example, the six Group ID bits may be repurposed to carry six BSS color bits, and a combination of the STBC bit and three reserved bits in VHT-SIG-A may be repurposed to carry four spatial reuse bits. Many other bit-mapping combinations across the available VHT-SIG-A and VHT-SIG-B fields are possible. In an alternative embodiment, the number of BSS color bits may be fewer than six (e.g., since the shorter range of ImmW at 60 GHz reduces the likelihood of encountering many overlapping BSSs), making it unnecessary to support as many distinct colors. Similarly, the number of spatial reuse bits may be reduced by increasing the step size between Parameter for Spatial Reuse (PSR) values or by omitting the higher-end values unlikely to be reached given propagation characteristics at ImmW operation (e.g., 60 GHz). The techniques described herein may also be extended beyond VHT format to other PHY formats whose SIG fields contain analogous unused or inapplicable bits, including High Efficiency (HE) (802.11ax) and Extremely High Throughput (EHT) (802.11be) formats.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

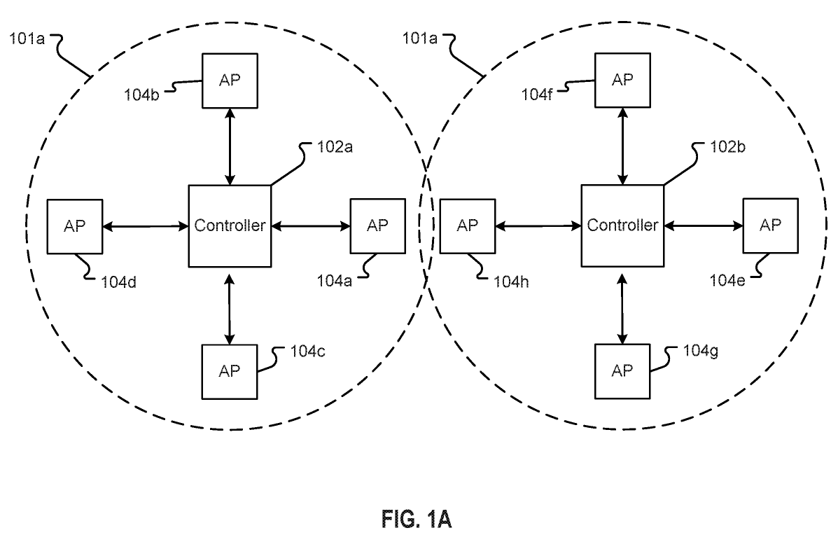

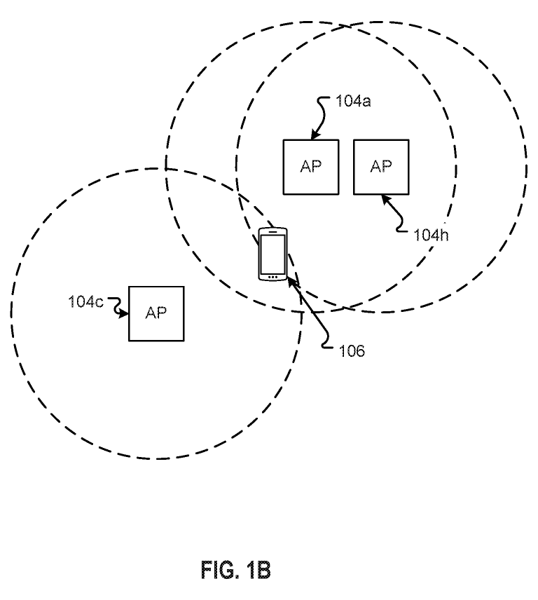

FIGS. 1A and FIG. 1B illustrate an operating environment 100 for providing frames that support BSS coloring and spatial reuse in ImmW operation. In the illustrated embodiment, the operating environment 100 includes a plurality of Extended Service Sets (ESSs) 101, such as a first ESS 101a and a second ESS 101b. Each ESS 101 can include one or more controllers 102, one or more access points (APs) 104, and one or more stations (STAs) 106.

For example, the first ESS 101a includes a controller 102a configured to manage one or more APs 104a, 104b, 104c, and 104d, and the second ESS 101b includes a controller 102b configured to manage one or more APs 104e, 104f, 104g, and 104h. The controllers 102a and 102b may comprise wireless local area network (WLAN) controllers, cloud-based network management entities, gateway devices, edge controllers, or other control entities configured to coordinate operation of associated APs. In certain embodiments, one or more of the APs 104 act as a controller and the controllers 102 are not separately present in the operating environment 100. For example, an AP 104 can include components to perform WLAN controller functions.

Each AP 104 provides wireless connectivity to one or more associated STAs 106 within a corresponding BSS. The STAs 106 may comprise, for example, mobile phones, laptop computers, tablet devices, wearable devices, sensors, vehicles, Internet-of-Things (IoT) devices, smart appliances, or other wireless communication devices capable of wireless communications.

The APs 104 and STAs 106 may communicate using one or more wireless communication protocols, including IEEE 802.11-based protocols. The wireless communications may utilize ImmW frequency bands between 42 GHz and 71 GHz, including for example communications at 60 GHz. In some implementations, the devices may additionally communicate using lower-frequency Wi-Fi bands, such as 2.4 GHz, 5 GHz, or 6 GHz bands, for broader coverage and reliability alongside the high-speed, short-range ImmW transmissions.

As illustrated in FIG. 1B, coverage areas associated with at least some APs 104 partially overlap. For example, a coverage region of AP 104a and a coverage region of AP 104c associated with the first ESS 101a may each overlap with each other and a coverage region of AP 104h associated with the second ESS 101b. Because wireless transmissions associated with different BSSs may occur within overlapping physical regions and on the same or overlapping frequency resources, contention, interference, or inefficient channel utilization may arise without a mechanism for distinguishing between BSSs.

To address this, the APs 104 and STAs 106 employ BSS coloring and spatial reuse techniques in ImmW operation. Each BSS is assigned a BSS color (e.g., a numerical identifier) that allows devices to distinguish frames originating from their own BSS from frames originating from a neighboring BSS. The BSS color assignment is typically coordinated by the AP 104 and/or controller 102, and the AP 104 announces the BSS color of its BSS in management frames, such as Beacon frames. Associated STAs 106 learn the color of their serving BSS from these announcements.

As further illustrated in FIG. 1B, a STA 106 (e.g., a client device) is located within the overlapping coverage regions of AP 104a, AP 104c, and AP 104h, and is associated with AP 104a in the first ESS 101a. Frames transmitted in either direction (i.e., from AP 104a to STA 106, or from STA 106 to AP 104a) may carry BSS color and spatial reuse information in the PHY layer signaling fields. When VHT frames are used, bits within the VHT-SIG fields of ImmW frames that are unused or inapplicable in the ImmW context, including bits associated with MU operation, STBC, and reserved fields, are repurposed to carry the BSS color value and spatial reuse parameters, without increasing the length of the transmitted frame.

Upon receiving a frame, the receiving device, whether STA 106 or AP 104a, reads the BSS color value from the repurposed SIG field bits and determines whether the detected transmission is an intra-BSS transmission (i.e., from its own BSS) or an inter-BSS transmission (i.e., from a neighboring BSS). For example, when the STA 106 detects a transmission from the AP 104h, or when the AP 104a detects a transmission from a neighboring AP or STA associated with a different BSS, the receiving device can evaluate the signal strength of that transmission against an applicable threshold, such as an overlapping BSS preamble detection threshold. If the signal from the neighboring BSS is weak enough that it is unlikely to cause harmful interference, the receiving device may elect to perform spatial reuse by transmitting concurrently rather than deferring, thereby improving overall channel efficiency. The spatial reuse parameters carried in the repurposed SIG bits inform this threshold determination. Accordingly, spatial reuse decisions may be made by the STA 106 while receiving neighboring AP or STA transmissions, by the AP 104a while receiving neighboring AP or STA transmissions, or by both simultaneously.

The environment 100 is provided solely as an illustrative example. In various implementations, the environment 100 may include additional or fewer ESSs, controllers, APs, STAs, network devices, communication links, or coverage relationships than those illustrated in FIGS. 1A and 1B. Further, although certain example components are illustrated as separate entities, some functions may be combined, distributed, virtualized, centralized, or otherwise implemented in different configurations.

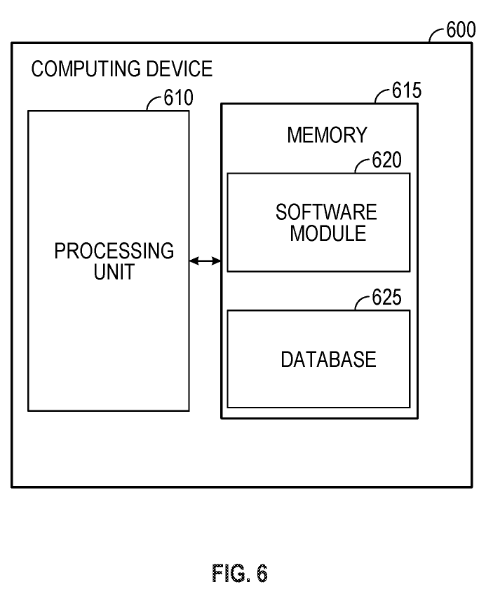

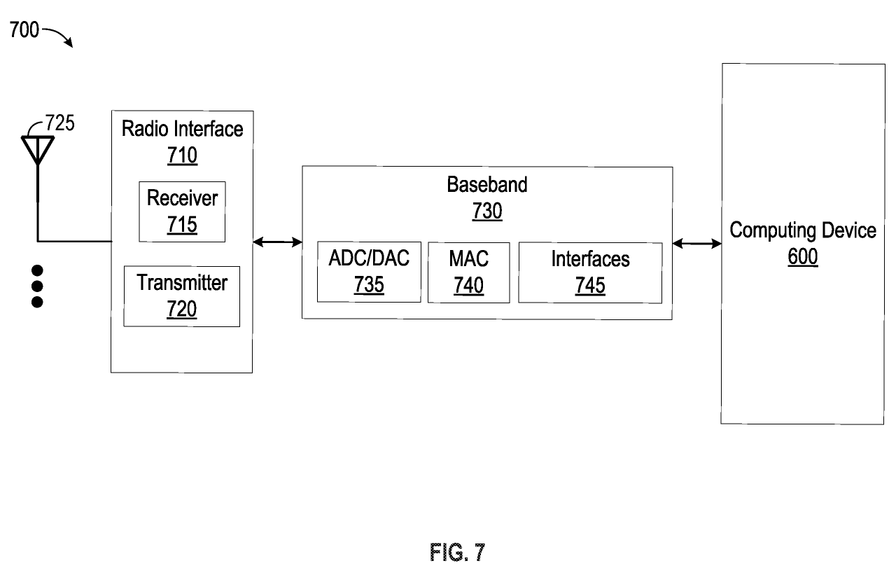

The elements described above of the operating environment 100 (e.g., the controllers 102, the APs 102, the STAs 106, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 6 and 7, the elements of the operating environment 100 may be practiced in a computing device 600 and/or communications device 700.

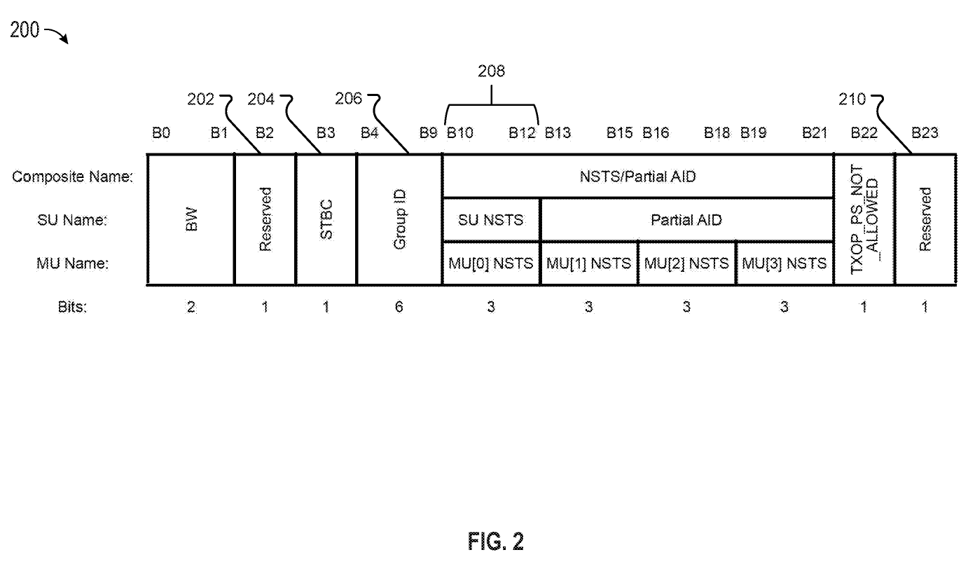

FIG. 2 illustrates a VHT-SIG-A1 symbol 200 of a VHT-SIG-A field. The VHT-SIG-A1 symbol 200 includes, among other bits and fields, a first reserved bit 202, an STBC bit 204, a Group ID field 206 six bits in length, an NSS field 208 three bits in length, and a second reserved bit 210. As illustrated, the NSS field 208 contains bits related to NSTS, which defines the NSS used in the transmission. In SU operation, NSTS is equivalent to NSS, so these bits effectively indicate the NSS.

As noted above, ImmW operation is limited to SU transmissions, and STBC is not planned to be supported in ImmW, as 60 GHz operation is intended to use low-density parity-check (LDPC) coding. As a result, certain bits within the VHT-SIG-A1 symbol 200 are unnecessary in the ImmW context and may be repurposed. Specifically, the first reserved bit 202 and the second reserved bit 210 carry no defined information and are available for repurposing. The STBC bit 204 is unnecessary because STBC is not supported in ImmW operation. The Group ID field 206 is unnecessary because MU transmissions are not supported in ImmW, making the group identifier irrelevant. Additionally, because 60 GHz does not support as many spatial streams as sub-7 GHz operation, two of the three bits of the NSS field 208 are also candidates for repurposing, as only a single bit is needed to indicate support for one or two spatial streams.

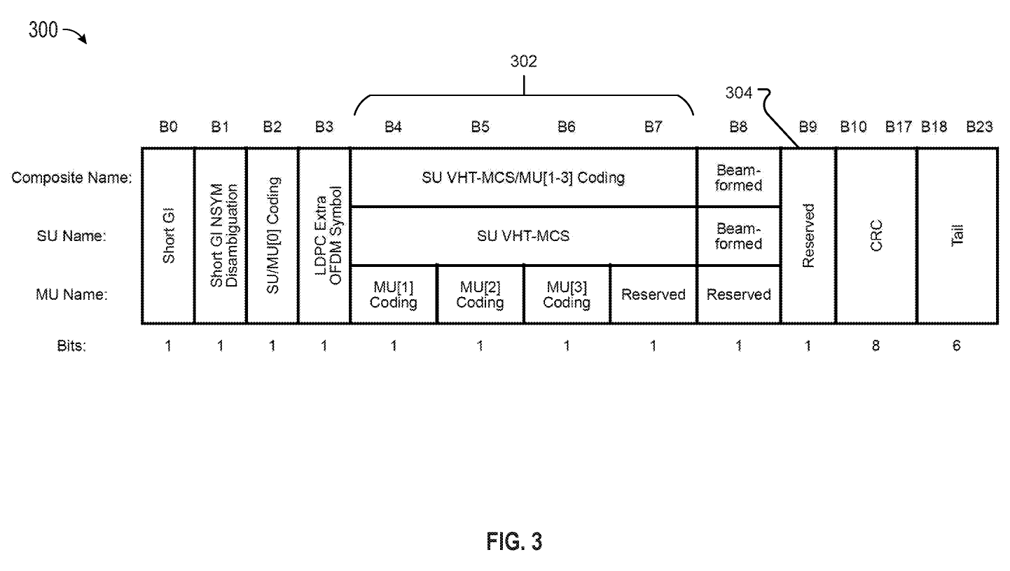

FIG. 3 illustrates a VHT-SIG-A2 symbol 300 of the VHT-SIG-A field. The VHT-SIG-A2 symbol 300 includes, among other bits and fields, an MCS field 302 four bits in length and a third reserved bit 304. The third reserved bit 304 carries no defined information and is available for repurposing. Additionally, because MCS values available in ImmW operation are more limited than in sub-7 GHz operation, one of the four bits of the MCS field 302 is also a candidate for repurposing. Accordingly, across the VHT-SIG-A1 symbol 200 and VHT-SIG-A2 symbol 300, there are thirteen bits that are unnecessary or inapplicable in ImmW, including the three reserved bits 202, 210, 304, the six Group ID field 206 bits, the STBC bit 204, two of the three NSS field 208 bits, and one of the four MCS field 302 bits.

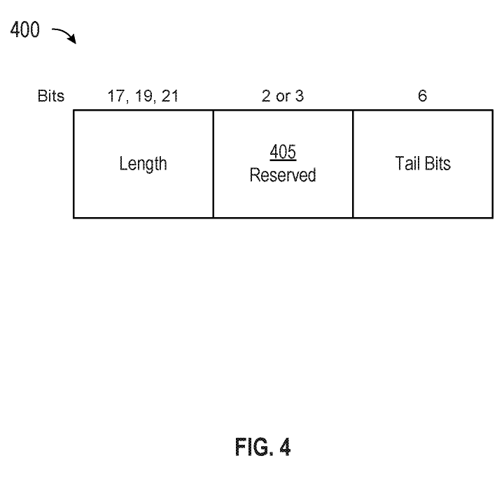

FIG. 4 illustrates a VHT-SIG-B field 400. The VHT-SIG-B field 400 includes a length field, reserved bits 405, and tail bits. The reserved bits 405 are two or three bits in length depending on the operating bandwidth. Because only a limited number of bandwidths are anticipated for use in ImmW operation at 60 GHz, the reserved bits 405 of the VHT-SIG-B field 400 are also available for repurposing.

The bits identified above across the VHT-SIG-A1 symbol 200, VHT-SIG-A2 symbol 300, and VHT-SIG-B field 400 are repurposed to carry BSS color and spatial reuse information in ImmW frames, without adding overhead or increasing the length of the transmitted frame. To support BSS coloring and spatial reuse in the same manner as defined in IEEE 802.11ax, six BSS color bits and four spatial reuse bits (ten bits in total) are used in example implementations. These ten bits may be drawn from any combination of the available bits identified above. In one example, the six BSS color bits are mapped to the Group ID field 206, and the four spatial reuse bits are mapped to a combination of the STBC bit 204 and the three reserved bits (e.g., the first reserved bit 202, the second reserved bit 210, and the third reserved bit 304). Many other combinations of available bits across the VHT-SIG-A1 symbol 200, VHT-SIG-A2 symbol 300, and VHT-SIG-B field 400 are also possible.

In some embodiments, less than six BSS color bits are included because the shorter range of ImmW at 60 GHz reduces the likelihood of encountering a large number of overlapping BSSs. With a limited number of potentially overlapping BSSs, fewer distinct color values are required for each overlapping BSS to have a unique value. Fewer spatial reuse bits may also be used for both trigger-based (TB) transmission and regular SU transmission cases. The four spatial reuse bits may be reduced to fewer bits either by increasing the step size between PSR values or by omitting the upper-end PSR values. The upper-end PSR values may be unlikely to be needed given the propagation characteristics of ImmW operation (e.g., at 60 GHz).

In some embodiments, the field mappings of HE-SIG-A may be applied to the corresponding VHT-SIG-A fields to achieve consistency in the mapping of general information to field assignments across PHY formats. Further, although the above description focuses on VHT format frames, the same approach of repurposing unused or inapplicable SIG field bits may be extended to other PHY formats, including HE (802.11ax) and EHT (802.11be) formats, which contain analogous fields with similar naming conventions that are likewise no longer relevant in the ImmW context and may be repurposed accordingly.

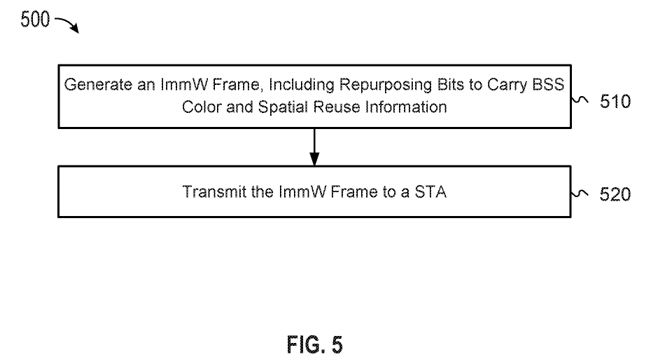

FIG. 5 illustrates a method 500 performed by an AP operating in an ImmW frequency band for generating and transmitting an ImmW frame carrying BSS color information and spatial reuse information. The method 500 may be performed by any of the APs 104 described with respect to FIGS. 1A and 1B, such as AP 104a. In further embodiments, STAs can perform the method 500, transmitting the generated ImmW frame to an AP.

At stage 510, the AP generates an ImmW frame, including repurposing one or more bits of a SIG field of a physical layer preamble of the ImmW frame to carry at least one of BSS color information or spatial reuse information. Because ImmW operation is limited to SU transmissions, certain bits within the SIG fields of the ImmW frame (e.g., bits defined for MU operation, STBC, and reserved fields) are unused or inapplicable in the ImmW context. Rather than leaving these bits unused or adding new fields to the frame, the AP repurposes these existing bits to carry BSS color information, spatial reuse information, or both, without adding overhead or increasing frame length.

In some embodiments, the SIG field is a VHT-SIG field, and the one or more repurposed bits comprise at least one of: a reserved bit, an STBC bit, a Group ID field bit, an NSS field bit, or an MCS bit of the VHT-SIG field. VHT format frames are used in ImmW operation to provide subcarrier spacing suited to operation at ImmW frequencies, which are more susceptible to phase noise than sub-7 GHz bands. In certain embodiments, the VHT-SIG field comprises a VHT-SIG-A1 symbol, and the one or more repurposed bits comprise at least one of: a first reserved bit, an STBC bit, one or more bits of a six-bit Group ID field, one or more bits of a three-bit NSS field, or a second reserved bit of the VHT-SIG-A1 symbol. The Group ID field bits are candidates for repurposing because MU transmissions are not supported in ImmW operation, rendering the Group ID field irrelevant. The STBC bit is a candidate for repurposing because STBC is not supported in ImmW operation, which uses LDPC coding exclusively. The NSS field bits are candidates for repurposing because ImmW operation supports fewer spatial streams than sub-7 GHz operation, such that fewer bits are needed to represent the number of spatial streams.

In one embodiment, the VHT-SIG field further comprises a VHT-SIG-A2 symbol, and the one or more repurposed bits further comprise at least one of: one or more bits of a four-bit MCS field or a reserved bit of the VHT-SIG-A2 symbol. The MCS field bits are candidates for repurposing because the range of MCS values supported in ImmW operation is more limited than in sub-7 GHz operation, such that fewer bits are needed to represent the applicable MCS values. In combination with the available bits of the VHT-SIG-A1 symbol described above, the VHT-SIG-A1 symbol and VHT-SIG-A2 symbol together provide up to thirteen bits available for repurposing across the two symbols. The VHT-SIG field further comprises a VHT-SIG-B field in certain embodiments, and the one or more repurposed bits further comprise one or more reserved bits of the VHT-SIG-B field. The VHT-SIG-B field includes two or three reserved bits depending on the operating bandwidth, all of which are available for repurposing in ImmW operation. In an alternative embodiment, field mappings from an HE-SIG-A field may be applied to the corresponding VHT-SIG-A fields to achieve consistency in the mapping of general information to field assignments across PHY formats.

In some embodiments, the one or more repurposed bits comprise six or fewer BSS color bits carrying the BSS color information and four or fewer spatial reuse bits carrying the spatial reuse information. In example implementations, six BSS color bits are mapped to the six-bit Group ID field of the VHT-SIG-A1 symbol, and four spatial reuse bits are mapped to a combination of the STBC bit of the VHT-SIG-A1 symbol and the reserved bits across the VHT-SIG-A1 and VHT-SIG-A2 symbols. Many other combinations of available bits across the VHT-SIG-A1 symbol, VHT-SIG-A2 symbol, and VHT-SIG-B field are usable.

In some implementations, the number of BSS color bits is fewer than six, reflecting the reduced likelihood of encountering a large number of overlapping BSSs in ImmW operation due to the shorter transmission range at ImmW frequencies. In example implementations, the number of spatial reuse bits is fewer than four, achieved either by increasing the step size between PSR values or by omitting upper-end PSR values that are unlikely to be reached given the propagation characteristics of ImmW operation.

At stage 520, the AP transmits the ImmW frame to the STA. The STA receives the ImmW frame. The STA reads the BSS color information and spatial reuse information from the repurposed bits of the SIG field to determine whether detected transmissions are intra-BSS or inter-BSS and to make spatial reuse decisions accordingly.

In some embodiments, the method 500 further comprises the AP receiving, from the STA, a second ImmW frame comprising one or more repurposed bits of a SIG field of a physical layer preamble of the second ImmW frame carrying BSS color information and spatial reuse information. The AP determines, based on the BSS color information in the second ImmW frame, whether the second ImmW frame is an intra-BSS transmission or an inter-BSS transmission. If the second ImmW frame is determined to be an inter-BSS transmission and its signal strength is below an applicable threshold (e.g., indicated in the spatial reuse information), the AP performs spatial reuse by transmitting concurrently with the detected inter-BSS transmission rather than deferring. Accordingly, spatial reuse decisions may be made by the AP, the STA, or both simultaneously.

In another embodiment, prior to transmitting the ImmW frame, the AP announces the BSS color assigned to its BSS in one or more management frames, such as Beacon frames or operation elements, so that associated STAs learn the BSS color of their serving BSS before receiving ImmW frames carrying the repurposed BSS color bits. In some embodiments, the techniques described with respect to method 500 are extended beyond VHT format frames to other PHY formats whose SIG fields contain analogous unused or inapplicable bits in the ImmW context, including HE (802.11ax) and EHT (802.11be) formats.

FIG. 6 is a block diagram of a computing device 600. As shown in FIG. 6, computing device 600 may include a processing unit 610 and a memory unit 615. Memory unit 615 may include a software module 620 and a database 625. While executing on processing unit 610, software module 620 may perform, for example, processes for providing frames for feature support in ImmW operation, including for BSS color and spatial reuse support. Computing device 600, for example, may provide an operating environment for the controllers 102, the APs 102, the STAs 106, and the like. The controllers 102, the APs 102, the STAs 106, and the like may operate in other environments and are not limited to computing device 600.

Computing device 600 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 600 may comprise any computer operating environment, such as hand-held devices, multiprocessor systems, microprocessor-based or programmable sender electronic devices, minicomputers, mainframe computers, and the like. Computing device 600 may also be practiced in distributed computing environments where tasks are performed by remote processing devices. The aforementioned systems and devices are examples, and computing device 600 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 600 on the single integrated circuit (chip).

FIG. 7 illustrates an implementation of a communications device 700 that may implement one or more of the controllers 102, the APs 102, the STAs 106, etc. In various implementations, the communications device 700 may comprise a logic circuit. The logic circuit may include physical circuits to perform operations described for one or more of the controllers 102, the APs 102, the STAs 106, etc., for example. As shown in FIG. 7, the communications device 700 may include one or more of, but is not limited to, a radio interface 710, baseband circuitry 730, and/or the computing device 600.

The communications device 700 may implement some or all of the structures and/or operations for the controllers 102, the APs 102, the STAs 106, etc., storage medium, and logic circuit in a single computing entity, such as entirely within a single device. Alternatively, the communications device 700 may distribute portions of the structure and/or operations using a distributed system architecture, such as a client station server architecture, a peer-to-peer architecture, a master-slave architecture, etc.

A radio interface 710, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 710 may include, for example, a receiver 715 and/or a transmitter 720. The radio interface 710 may include bias controls, a crystal oscillator, and/or one or more antennas 725. In additional or alternative configurations, the radio interface 710 may use oscillators and/or one or more filters, as desired.

The baseband circuitry 730 may communicate with the radio interface 710 to process, receive, and/or transmit signals and may include, for example, an Analog-To-Digital Converter (ADC) for down converting received signals with a Digital-To-Analog Converter (DAC) 735 for up converting signals for transmission. Further, the baseband circuitry 730 may include a baseband or PHY layer processing circuit for the PHY link layer processing of respective receive/transmit signals. Baseband circuitry 730 may include, for example, a Media Access Control (MAC) processing circuit 740 for MAC/data link layer processing. Baseband circuitry 730 may include a memory controller for communicating with MAC processing circuit 740 and/or a computing device 600, for example, via one or more interfaces 745.

In some configurations, PHY processing circuit may include a frame construction and/or detection module, in combination with additional circuitry such as a buffer memory, to construct and/or deconstruct communication frames. Alternatively or in addition, MAC processing circuit 740 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
generating, by an access point (AP) operating in an integrated millimeter wave (ImmW) frequency band, an ImmW frame, including repurposing one or more bits of a signal (SIG) field of a physical layer preamble of the ImmW frame to carry at least one of basic service set (BSS) color information or spatial reuse information; and
transmitting the ImmW frame to a station (STA).

2. The method of claim 1, wherein:
the SIG field is a very high throughput (VHT)-SIG field; and
the one or more bits comprise at least one of: a reserved bit, a space-time block coding (STBC) bit, a group ID field bit, a number of spatial streams (NSS) field bit, or a modulation and coding scheme (MCS) bit.

3. The method of claim 1, wherein:
the SIG field is a VHT-SIG field comprising a VHT-SIG-A1 symbol; and
the one or more bits comprise at least one of: a first reserved bit, an STBC bit, one or more bits of a six-bit Group ID field, one or more bits of a three-bit NSS field, or a second reserved bit of the VHT-SIG-A1 symbol.

4. The method of claim 3, wherein:
the VHT-SIG field further comprises a VHT-SIG-A2 symbol; and
the one or more bits further comprise at least one of: one or more bits of a four-bit MCS field or a reserved bit of the VHT-SIG-A2 symbol.

5. The method of claim 3, wherein:
the VHT-SIG field further comprises a VHT-SIG-B field; and
the one or more bits further comprise one or more reserved bits of the VHT-SIG-B field.

6. The method of claim 1, wherein the one or more bits comprise:
six or fewer BSS color bits carrying the BSS color information; and
four or fewer spatial reuse bits carrying the spatial reuse information.

7. The method of claim 1, further comprising:
receiving, from the STA, a second ImmW frame comprising one or more repurposed bits of a SIG field of a physical layer preamble of the second ImmW frame carrying BSS color information and spatial reuse information; and
determining, based on the BSS color information in the second ImmW frame, whether the second ImmW frame is an intra-BSS transmission or an inter-BSS transmission; and
performing spatial reuse by transmitting concurrently with a detected inter-BSS transmission when a signal strength of the inter-BSS transmission is below a threshold.

8. The method of claim 1, wherein the one or more bits comprise three or fewer bits carrying spatial reuse information by increasing a step size between parameter for spatial reuse (PSR) values or omitting one or more upper-end PSR values.

9. A system comprising:
a memory storage; and
a processing unit coupled to the memory storage, wherein the processing unit is operative to:
generate an integrated millimeter wave (ImmW) frame, including repurposing one or more bits of a signal (SIG) field of a physical layer preamble of the ImmW frame to carry at least one of basic service set (BSS) color information or spatial reuse information; and
transmit the ImmW frame to a station (STA).

10. The system of claim 9, wherein:
the SIG field is a very high throughput (VHT)-SIG field; and
the one or more bits comprise at least one of: a reserved bit, a space-time block coding (STBC) bit, a group ID field bit, a number of spatial streams (NSS) field bit, or a modulation and coding scheme (MCS) bit.

11. The system of claim 9, wherein:
the SIG field is a VHT-SIG field comprising a VHT-SIG-A1 symbol; and
the one or more bits comprise at least one of: a first reserved bit, an STBC bit, one or more bits of a six-bit Group ID field, one or more bits of a three-bit NSS field, or a second reserved bit of the VHT-SIG-A1 symbol.

12. The system of claim 11, wherein:
the VHT-SIG field further comprises a VHT-SIG-A2 symbol; and
the one or more bits further comprise at least one of: one or more bits of a four-bit MCS field or a reserved bit of the VHT-SIG-A2 symbol.

13. The system of claim 11, wherein:
the VHT-SIG field further comprises a VHT-SIG-B field; and
the one or more bits further comprise one or more reserved bits of the VHT-SIG-B field.

14. The system of claim 9, wherein the one or more bits comprise:
six or fewer BSS color bits carrying the BSS color information; and
four or fewer spatial reuse bits carrying the spatial reuse information.

15. A non-transitory computer-readable medium that stores a set of instructions which when executed by a processing unit, cause the processing unit to perform a method comprising:
generating an integrated millimeter wave (ImmW) frame, including repurposing one or more bits of a signal (SIG) field of a physical layer preamble of the ImmW frame to carry at least one of basic service set (BSS) color information or spatial reuse information; and
transmitting the ImmW frame to a station (STA).

16. The non-transitory computer-readable medium of claim 15, wherein:
the SIG field is a very high throughput (VHT)-SIG field; and
the one or more bits comprise at least one of: a reserved bit, a space-time block coding (STBC) bit, a group ID field bit, a number of spatial streams (NSS) field bit, or a modulation and coding scheme (MCS) bit.

17. The non-transitory computer-readable medium of claim 15, wherein:
the SIG field is a VHT-SIG field comprising a VHT-SIG-A1 symbol; and
the one or more bits comprise at least one of: a first reserved bit, an STBC bit, one or more bits of a six-bit Group ID field, one or more bits of a three-bit NSS field, or a second reserved bit of the VHT-SIG-A1 symbol.

18. The non-transitory computer-readable medium of claim 17, wherein:
the VHT-SIG field further comprises a VHT-SIG-A2 symbol; and
the one or more bits further comprise at least one of: one or more bits of a four-bit MCS field or a reserved bit of the VHT-SIG-A2 symbol.

19. The non-transitory computer-readable medium of claim 17, wherein:
the VHT-SIG field further comprises a VHT-SIG-B field; and
the one or more bits further comprise one or more reserved bits of the VHT-SIG-B field.

20. The non-transitory computer-readable medium of claim 15, wherein the one or more bits comprise:
six or fewer BSS color bits carrying the BSS color information; and
four or fewer spatial reuse bits carrying the spatial reuse information.
